(19) United States
(12) Patent Application Publication
(10) Pub. No.: US 2022/0086194 A1
(43) Pub. Date: Mar. 17, 2022

(54) SECURITY CONFIGURATION MANAGER

(71) Applicant: FireScope, Inc., Huntington Beach, CA (US)

(72) Inventor: KENNETH WALTER ADAMSON, Winchester, CA (US)

(73) Assignee: FireScope, Inc., Huntington Beach, CA (US)

(21) Appl. No.: 17/478,701

(22) Filed: Sep. 17, 2021

Related U.S. Application Data
(60) Provisional application No. 63/080,014, filed on Sep. 17, 2020.

(51) Int. Cl. H04L 29/06; H04L 12/24; G06F 3/0482

(52) U.S. Cl. CPC H04L 63/205; H04L 63/101; G06F 3/0482; H04L 41/0893; H04L 41/22; H04L 41/0853

(57) ABSTRACT

Apparatuses, methods, systems, and program products are disclosed for security configuration management. An apparatus includes an asset module that identifies a plurality of network assets of a data network comprising a plurality of interconnected physical and virtual computing components. An apparatus includes a security module that monitors changes in security controls and configurations for the interconnected physical and virtual computing components of the network assets relative to an applied security configuration policy. An apparatus includes an interface module that notifies a user of a monitored change in the security controls and configurations and graphically presents a user interface to the user comprising one or more actions in response to the monitored change.

### CROSS-REFERENCES TO RELATED APPLICATIONS

This application claims the benefit of U.S. Provisional Patent Application No. 63/080,014 entitled “SECURITY CONFIGURATION MANAGER” and filed on Sep. 17, 2020, for Kenneth Walter Adamson, which is incorporated herein by reference.

### FIELD

This invention relates to security controls and more particularly relates to applying security configuration policies and monitoring security controls.

### BACKGROUND

Computer security breaches are an ever-increasing threat as the use of computer technology continues to grow and evolve. Many security solutions are not transparent for configuration or management, making audits difficult and providing little or no insight on compliance or potential misconfigurations.

### SUMMARY

Apparatuses, methods, systems, and program products are disclosed for security configuration management. An apparatus, in one embodiment, includes an asset module that identifies a plurality of network assets of a data network, and the plurality of network assets comprises a plurality of interconnected physical and virtual computing components. An apparatus, in a further embodiment, includes a security module that monitors changes in security controls and configurations for the interconnected physical and virtual computing components of the network assets relative to an applied security configuration policy. In some embodiments, an apparatus includes an interface module that notifies a user of a monitored change in the security controls and configurations and graphically presents a user interface to the user comprising one or more actions in response to the monitored change. At least a portion of the modules, in certain embodiments, comprise one or more of hardware circuits, programmable hardware circuits, and executable code, the executable code stored on one or more non-transitory computer readable storage media.

A method, in one embodiment, includes identifying a plurality of network assets of a data network, where the plurality of network assets comprising a plurality of interconnected physical and virtual computing components. In some embodiments, a method includes monitoring changes in security controls and configurations for the interconnected physical and virtual computing components of the network assets relative to an applied security configuration policy. A method, in certain embodiments, includes notifying a user of a monitored change in the security controls and configurations. In a further embodiment, a method includes graphically presenting a user interface to the user comprising one or more actions in response to the monitored change.

An apparatus, in one embodiment, includes means for identifying a plurality of network assets of a data network, where the plurality of network assets comprising a plurality of interconnected physical and virtual computing components. In certain embodiments, an apparatus includes means for monitoring changes in security controls and configurations for the interconnected physical and virtual computing components of the network assets relative to an applied security configuration policy. An apparatus, in some embodiments, includes means for notifying a user of a monitored change in the security controls and configurations. In one embodiment, an apparatus includes means for graphically presenting a user interface to the user comprising one or more actions in response to the monitored change.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for security configuration management;

FIG. 2 is a schematic block diagram illustrating an apparatus for security configuration management;

FIG. 3 is an example interface for security configuration management;

FIG. 4 is an example network topology map for security configuration management;

FIG. 5 is a schematic block diagram illustrating one embodiment of a method for security configuration management;

FIG. 6 is a schematic block diagram illustrating one embodiment of another method for security configuration management; and

FIG. 7 is a schematic block diagram illustrating one embodiment of a further method for security configuration management.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to emphasize their implementation independence more particularly. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

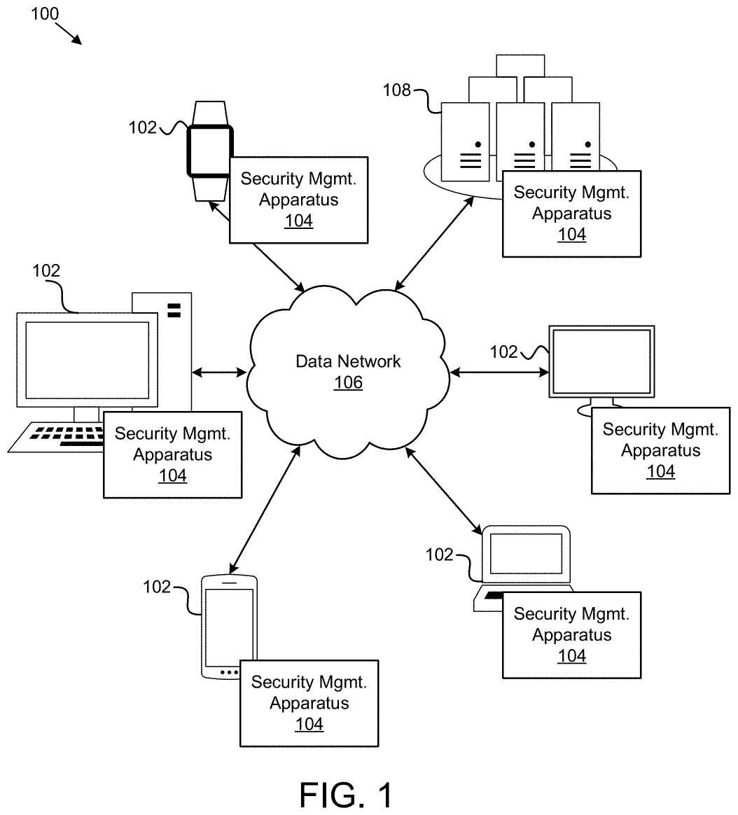

FIG. 1 is a schematic block diagram illustrating one embodiment of a system 100 for security configuration management. In one embodiment, the system 100 includes one or more information handling devices 102, one or more security management apparatuses 104, one or more data networks 106, and one or more servers 108. In certain embodiments, even though a specific number of information handling devices 102, security management apparatuses 104, data networks 106, and servers 108 are depicted in FIG. 1, one of skill in the art will recognize, in light of this disclosure, that any number of information handling devices 102, security management apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In certain embodiments, the information handling devices 102 include network devices such as servers, routers, switches, bridges, and/or the like. In some embodiments, the information handling device 102 are used for virtualization within the data network 106 such as for hosting hypervisors, virtual machines, virtual containers, and/or the like. In certain embodiments, the network devices are logically grouped according to a service, e.g., an application service that the group of network devices provides, e.g., an online message service, a networked storage service, and/or the like.

In general, in one embodiment, the security management apparatus 104 is configured to identify a plurality of network assets of a data network 106, which may include a plurality of physical and virtual computing components that are interconnected via the data network 106, calculate a risk level for each of the plurality of network assets based on a plurality of factors, and provide an interactive interface that graphically presents the data network 106 and visually highlights each of the plurality of network assets according to their calculated risk levels.

In further embodiments, the security management apparatus 104 is configured to identify a plurality of network assets of a data network 106, which may include a plurality of physical and virtual computing components that are interconnected via the data network 106, determine dependencies between the plurality of network assets across different physical and virtual layers within the data network 106, and generate a snapshot of the plurality of network assets and the dependencies between the plurality of network assets across the different physical and virtual layers within the data network 106 at a point in time.

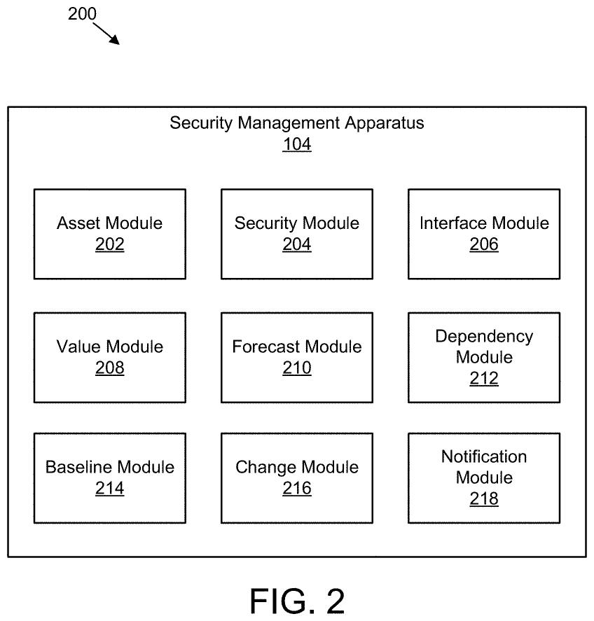

In this manner, the security management apparatus 104 may identify the network assets that are part of a business or service and determine potential risks that each network asset poses to the business, service, or the like, based on various factors such as reliability, impact, security, and health of the network asset. Moreover, the security management apparatus 104 may generate a baseline snapshot of a data network, or a portion of the data network that provides a service, to identify security risks or changes within the data network that may be threat to the network functioning at a particular service level. The security management apparatus 104 is described in more detail below with reference to FIG. 2.

In certain embodiments, the security management apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the security management apparatus 104 may include a power interface, a wired and/or wireless network interface, a graphical interface that attaches to a display, and/or a semiconductor integrated circuit device as described below, configured to perform the functions described herein with regard to the security management apparatus 104.

The security management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the security management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the security management apparatus 104.

The semiconductor integrated circuit device or other hardware appliance of the security management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the security management apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may be configured to provide a service, e.g., a business or application service at a predetermined service level, e.g., according to a service level agreement.

FIG. 2 is a schematic block diagram illustrating one embodiment of an apparatus 200 for security configuration management. In one embodiment, the apparatus 200 includes an instance of a security management apparatus 104. In one embodiment, the security management apparatus 104 includes an asset module 202, a security module 204, an interface module 206, a value module 208, a forecast module 210, a dependency module 212, a baseline module 214, a change module 216, and a notification module 218, which are described in more detail below.

In one embodiment, the asset module 202 is configured to identify a plurality of network assets of a data network. In certain embodiments, the plurality of network assets comprises a plurality of interconnected physical and virtual computing components. As described above, the physical components may include hardware devices such as computers, servers, Internet of Things devices, routers, switches, bridges, storage devices, and/or the like. The virtual computing components, in certain embodiments, include such things as programs, applications, operating systems, virtual machines, hypervisors, and/or the like.

In one embodiment, the asset module 202 may determine a topology or mapping of the data network 106 using various network discovery methods such as using broadcast pings, internet protocol (“IP”) scan tools, address resolution protocol (“ARP”) cache discovery, a traceroute command, and/or the like. The asset module 202 may create a registry, list, journal, table, or the like of the network assets within the network at a given point in time and the connections between the different network assets. As described above, the asset module 202 may determine network assets that are logically grouped together to provide a service, e.g., a service group.

In certain embodiments, the security module 204 enables a user to apply security configuration policies to a baseline map, or the like and/or to monitor for one or more misconfigured security controls or devices (e.g., network assets, interconnected physical and/or virtual computing components, or the like), at an individual network asset level and/or an overall service level, or the like. Use of the security module 204 may expedite audit readiness (e.g., reducing audit readiness costs, or the like), provide network transparency, provide insight into compliance and/or security posture, provide a virtual security configuration perimeter around business services and/or high value assets, provide one or more real-time alerts (e.g., a misconfiguration alert, a noncompliance alert, or the like), audit service security configuration policies (e.g., in real-time), or the like.

The security module 204, in one embodiment, is configured to monitor one or more attack vectors, applications, virtualization, networks, storage devices, or the like. In some embodiments, the security module 204 may be configured to automatically detect one or more changes and/or threats, and may alert a user, or the like. The security module 204 may perform a service-based security risk analysis. In one embodiment, the security module 204 may comprise one or more secure industrial controllers, supervisory control and data acquisition (SCADA) equipment and/or endpoints (e.g., a system for gathering and/or analyzing real-time data to monitor and/or control network assets), or the like. The security module 204 may be configured to follow one or more best-practice security configuration policies (e.g., National Institute of Standards and Technology (NIST), International Organization for Standardization (ISO), Payment Card Industry Data Security Standard (PCI-DSS), or the like). In certain embodiments, the security module 204 may integrate with one or more security orchestration, information technology service management (ITSM), and/or security information and event management (STEM) tools.

In some embodiments, one or more features of the security module 204 may use, integrate with, depend on, and/or comprise a discover tool, a dependency mapping tool, or the like. For example, a discovery process, a dependency mapping process, or the like may execute prior to the security module 204 applying a security configuration policy.

A user, in one embodiment, may define and apply one or more security configuration policies to a baseline map using the security module 204 (e.g., through a user interface of the interface module 206, or the like). For example, the security module 204 may enable a user to create a security configuration policy with one or more whitelists of trusted protocols for a service, for a network asset, or the like (e.g., the security module 204 may provide a standard set of out-of-the-box whitelists containing secure protocols according to various security standards such as NIST, ISO, PCI-DSS, or the like); with one or more blacklists of untrusted or known suspicious protocols for a service, for a network asset, or the like (e.g., the security module 204 may provide a standard set of out-of-the-box blacklists of unsecure or suspicious protocols according to various security standards such as NIST, ISO, PCI-DSS, or the like); and/or other lists.

In some embodiments, the security module 204 may allow a user to define, for each network asset in a baseline map or other list (e.g., using a user interface of the interface module 206 or the like), a whitelist of approved protocols (e.g., ports or the like) and for each protocol choose a direction (e.g., inbound, outbound, or both), a whitelist of approved neighbors (e.g., network assets, a neighborhood watch, or other neighbor), or the like. The security module 204, in certain embodiments, may allow a user to define one or more actions (e.g., an alert, opening an incident with an ITSM solution, sending an email, triggering orchestration, alerting a SIEM service, quarantining a device, reconfiguring a device, or the like), in a user interface of the interface module 206. The one or more actions, in one embodiment, may be dynamically selectable by a user in the user interface of the interface module 206, and the security module 204 may execute a selected action in response to the user selecting the action within the user interface. In a further embodiment, the one or more actions may be preselected and/or preauthorized by a user (e.g., during setup, configuration, or the like) and the security module 204 may automatically execute the one or more actions in response to a predefined change in monitored security controls and/or configurations of a network asset, or the like.

In one embodiment, the security module 204 may integrate with an STEM tool and/or service, or the like (e.g., endpoint to cloud security configuration management, to ensure only secured endpoints access the service, or the like).

The security module 204, in certain embodiments, may automatically discover connected assets and their application, network, virtual and storage dependencies and allow a user to define the collection of these assets and dependencies into a logical group such as a business service baseline map or other baseline map (e.g., in cooperation with the asset module 202 and/or the baseline module 214, or the like). Once the baseline map is defined and approved, the security module 204 may monitor for changes to the baseline and notify users of changes via emails, text message, or visually in the user interface of the interface module 206 so the user may review, identify a possible security threat, verify approved changes to the baseline map, or the like.

In one embodiment, the security module 204 is configured to calculate a risk level for each of the plurality of network assets based on a plurality of factors. As used herein, a risk level for a network asset may describe a threat that an asset is to the data network 106 being capable of functioning at a predetermined service level. In other words, the risk level indicates how likely a device is to have a detrimental impact on providing a service, e.g., an online shopping service.

In one embodiment, the risk level is calculated based on an average metric for the plurality of factors. The plurality of factors may include an impact factor, a security factor, a health factor, and a reliability factor for an asset, and the average metric may include an average of an impact metric, a security metric, a health metric, and a reliability metric.

In one embodiment, the impact metric comprises an impact that a network asset may have on other network components, on the network as a whole, on a service, and/or the like, e.g., other network assets that a network asset has dependencies with. The impact matric may be determined based on at least one of a number of neighboring assets, a number of dependencies, a number of dependencies to high value assets, a number of service groups directly associated with the asset, a number of service groups indirectly associated with the asset, an asset value score, an asset type, and/or the like.

In one embodiment, the security metric comprises a measurement of a security risk that the network asset is to the data network. The security metric may be determined based on at least one of a number of authorized changes, a number of unauthorized changes, a number of vulnerabilities, a benchmark number of vulnerabilities, an asset type, a number of neighbors to the asset that have a risk level that satisfies a predetermined threshold, and/or the like.

In one embodiment, the health metric comprises an indication of the probability that a network asset may fail. In one embodiment, the health metric is determined based on at least one of an average percentage of available processing, an average percentage of available memory, an average percentage of available storage, an average availability percentage (e.g., if available 99% of the time or 50% of time), an average network capacity, and/or the like.

In one embodiment, the reliability metric comprises an indication of how reliable a network asset it, e.g., how often the network asset is unavailable. In one embodiment, the reliability metric is determined based on at least one of a number of critical alerts, a number of incidents, a benchmark number of critical alerts, a benchmark number of incidents, a history of service tickets, a number of vendor updates, and/or the like.

In one embodiment, the security module 204 assigns a weight to at least one of the plurality of factors. As used herein, the assigned weight indicates an importance of a factor relative to other factors of the plurality of factors and used in the calculation of the risk level. For example, the security module 204 may weigh the security factor higher than the health factor and may assign weights to the security and health factors accordingly, which may be considered when the risk level of the network asset is calculated.

In one embodiment, the interface module 206 is configured to provide an interactive interface that graphically presents the data network and visually highlights each of the plurality of network assets according to their calculated risk levels. The interactive interface may include a graphical map illustrating the topology of the data network 106, including the connections between different devices and applications within the data network 106. In certain embodiments, the interactive interface includes a list, table, spreadsheet, or the like that presents information for each of the network assets within the data network 106.

In one embodiment, the value module 208 is configured to calculate an asset value score for each of the plurality of network assets. As used herein, the asset value score indicates an importance of the network asset to the data network 160 being capable of functioning at a predetermined service level. For example, a network device that is a single point of failure, e.g., if the network device fails, the provided service becomes unavailable, may have a high asset value score whereas a redundant network switch may have a lower asset value score.

In one embodiment, the value module 208 calculates the asset value score for the asset based on at least one of a neighborhood size associated with the asset, a number of dependencies for the asset, a number of dependencies that have an asset value score that satisfies a threshold, a number of service groups directly associated with the asset, and a number of service groups indirectly associated with the asset. As used herein, a neighbor of a target network asset may be another network asset that is one hop away from the target network asset. In further embodiments, a neighborhood, as used herein, may refer to immediate neighbors associated with a single target asset.

In one embodiment, the interface module 206 visually highlights the plurality of network assets according to their asset value score within the interactive interface. For instance, the interface module 206 may assign colors to ranges of asset value scores such that a network asset is assigned a color that corresponds to the asset value score range that the network asset's value score falls in. For example, an asset value score range of 80-100 may indicate high importance and the color may be red, whereas a range of 0-20 may be of lowest importance so the assigned color may stand out less.

In one embodiment, the interface module 206 presents each of the plurality of network assets in the interactive interface and, in response to receiving a selection of one of the presented network assets, presents the calculated risk level and metrics for each of plurality of factors used to calculate the risk level for the selected network asset, presents a status of monitored security controls and/or configurations for the selected network asset, or the like. For instance, on a graphical representation of a topological map of the data network, or a subset of the data network (e.g., a mapping of a service group), the interface module 206 may present the calculated risk level information for a network asset that is selected, a status of monitored security controls and/or configurations for the selected network asset, or the like.

In such an embodiment, the interactive interface may include a graphical network topology map that illustrates each of the plurality of network assets and network connections between the plurality of network assets where each of the plurality of network assets is graphically represented on the network topology map and highlighted according to the calculated risk level for the network asset, according to security controls/configurations, or the like (e.g., network assets with risk levels above eighty may be highlighted red, while network assets with risk levels below fifty may be highlighted green, or the like).

In one embodiment, the interactive interface comprises a graphical heatmap for at least a subset of the plurality of network assets that involved in delivering a service. As used herein, the graphical heatmap may provide a color-coding scheme for indicating the calculated risk level for each of a subset of the plurality of network assets that are involved in delivering the service, monitored security controls and/or configurations for the subset of the plurality of network assets that are involved in delivering the service, or the like. The heatmap for instance, may rank, sort, and/or list network assets according to their calculated risk levels such that higher risk network assets are presented or listed below other, lower risk network assets.

In one embodiment, the plurality of network assets that are graphically presented within the interactive interface are sortable on the plurality of factors that are used to calculate the risk levels the plurality of network assets. For instance, the interface module 206 may receive input on a column that represents the security dimension of the plurality of factors for each of the network assets and the presented list or network assets may be sorted in descending order of security metric so that the network assets with the highest security risk are listed first.

In one embodiment, the forecast module 210 predicts an impact that each of the plurality of network assets has on the capability of the data network functioning at a predetermined service level based on the calculated risk level, an applied security configuration policy, the plurality of factors for each of the plurality of network assets, or the like. For instance, the forecast module 210 may use machine learning to estimate or predict the impact of a network asset. For example, a machine learning model may be regularly trained on an ongoing basis using data associated with the plurality of factors that are used to calculate the risk level. Metric data for the plurality of factors may be input into the machine learning model to generate a prediction or estimate for the network asset's overall risk level, the network asset's predicted health, security, impact, and/or reliability on the data network 106, and/or the like.

In this manner, the security management apparatus 104 identifies which network assets have the highest likelihood of interrupting a service being provided by at least a subset of the network assets in the data network 106 based on at least four different factors—reliability, impact, security, and health—which are each considered to calculate an overall (average) risk level for a network asset.

In one embodiment, the dependency module 212 determines dependencies between the plurality of network assets across different physical and virtual layers within the data network. A dependency, as used herein, may be a network asset that is dependent upon another network asset, e.g., in a directed network, in order to function properly. An example may be a server that is dependent upon a network storage device for servicing data requests for data that is stored on the network storage device.

In one embodiment, the dependency module 212 may monitor network traffic (e.g., on incoming and outgoing ports), may use a traceroute command, and/or the like to determine the path through the data network 106, a path through a service group, and/or the like to determine which network assets are dependent upon other network assets within the data network 106. In certain embodiments, the dependency module 212 identifies dependencies within the data network 106 by tracing data packets on the network (e.g., NetFlow), by interfacing with hypervisor APIs (e.g., Hyper-V, V-center, or the like), storage vendor APIs (e.g., simple network management protocol (“SNMP”)), device APIs (e.g., SNMP), and/or the like.

In one embodiment, the different physical and virtual layers comprise a user layer, a device layer, an application layer, a virtualization layer, a cloud layer, a network layer, a storage layer, and/or the like. For instance, the application layer provides details about how applications, endpoints, and servers communicate over the network, which may be important for discovering dependency relationships include source and target IP addresses/hostnames, the direction of communication, and which ports and protocols are being used. In another example, the virtualization layer and/or cloud layer provides details dependencies of hosts, guests, virtual switches and storage as well as detailed asset information such as operating systems and capacity and performance.

Furthermore, the network layer, for example, provides network connectivity dependencies between applications, servers, and clients and helps identify single points of failure. The storage layer, in another example, provides local data store and network attached storage dependencies for both hosts and guests.

In one embodiment, the baseline module 214 generates a snapshot of the plurality of network assets and the dependencies between the plurality of network assets across the different physical and virtual layers within the data network at a point in time. In such an embodiment, the baseline module 214 takes a snapshot of the data network 106 at a point in time, and may update the snapshot periodically, e.g., every day, every week, or the like, or in response to detecting a change in the data network 106. Accordingly, a snapshot of the data network 106 may be used to detect changes within the data network, e.g., by comparing the snapshot to a current state of the data network 106 to identify differences between the snapshot and the current state.

In one embodiment, a snapshot is for at least a subset of the plurality of network assets and the dependencies between the plurality of network assets across the different physical and virtual layers within the data network that are involved in providing a service, e.g., a service group. For example, the baseline module 214 may generate a snapshot of a subset of the data network 106 that includes a server, two switches, a router, and a network storage device, which are all involved in providing a particular service.

In one embodiment, the change module 216 detects, in real-time, a change in the data network from the snapshot of the data network that the baseline module 214 generates. The change module 216, in one embodiment, may periodically compare a current state of the data network 106 to a corresponding snapshot to determine if there are new devices added to the data network 106, if there are devices that have been removed from the data network 106, if there are new or removed programs or applications, if there are new or removed virtual machines, and/or the like. In certain embodiments, the change module 206 monitors for changes in the data network 106 or for changes in a service group (e.g., for new network assets, removed network assets, changes in existing network assets, or the like) continuously (e.g., in real-time), periodically (e.g., every hour, every day, or the like), and/or the like. In certain embodiments, users can configure network ranges or subnet ranges to be scanned/monitored to discover network asset changes.

In one embodiment, the notification module 218 sends a notification, message, or the like in response to detecting the change in the data network. The notification may include an email, a push notification, a text message, a social media message, opening a case or ticket in an incident management system, and/or the like. The notification may be sent to an administrator, operations manager, and/or the like. In one embodiment, the notification includes a confirmation to determine whether the detected change is an authorized change in the data network. For instance, the notification may include information describing the detected change, e.g., a new virtual machine coming online, and may prompt the user to confirm that the detected change is authorized or not.

In response to receiving confirmation that the change is an authorized change, the baseline module 214 generates a new snapshot of the plurality of network assets and the dependencies between the plurality of network assets to reflect the detected change, e.g., to add the detected change to the baseline snapshot. Otherwise, if the detected change is not an authorized change in the data network, the notification comprises an alert to indicate a potential security risk. The notification module 218 may send the alert to interested parties such as a network administrator, a security firm, and/or another IT administrator.

In one embodiment, the interface module 206 provides an interactive interface that graphically presents the plurality of network assets, the dependencies between the plurality of network assets, and the different physical and virtual layers for the snapshot of the data network in a topological network map. In such an embodiment, the different virtual layers, and the dependencies between the plurality of network assets between the different virtual layers, are selectively shown and hidden on the topological network map.

For example, a user may unselect the storage layer from being visible on the topological network map such that storage devices and their connections to other devices are hidden on the map. In another example, a user may select only the device layer to see network devices and their dependencies for a service group that is involved in providing a particular network service, e.g., an online shopping application. The network assets that are part of a layer may be highlighted, colored, flagged, or the like to visually indicate which layer(s) the network assets belong to.

In one embodiment, the interface module 206 visually highlights changes that are detected within the data network as compared to the generated snapshot on the topological network map. For instance, the changes may be visually depicted with broken or dashed lines, with a different color or highlight, with a different font style, and/or the like. A user may select the depicted changes and add them to the baseline snapshot. Similarly, different types of dependencies may be selectively shown and hidden on the topological network map, e.g., physical dependencies between computing devices, network devices, storage devices, and/or the like; virtual dependencies based on an API, virtual machines, programs, applications, and/or the like.

In one embodiment, the interface module 206 graphically depicts on the interactive interface at least a subset of the plurality of network assets, the dependencies between the plurality of network assets, and the different physical and virtual layers that are involved in providing a service, e.g., a service group. The network assets within a service group may be colored the same, flagged the same, outlined with a dashed or broken line, or the like to indicate that they are part of the same service group. Different service groups may be selected to be shown or hidden within the interactive interface. Moreover, additional information may be provided, e.g., in a tooltip, in a separate window, or the like, in response to a user selecting a network asset, hovering over a network asset, and/or the like.

In this manner, the security management apparatus 104 provides a baseline snapshot of a service map, or a data network 106 in general, across different layers to identify security risks and other changes to the baseline snapshot that could potentially be a security concern or may otherwise impact the capability of the data network 106 or service group to provide a service at a predefined service level.

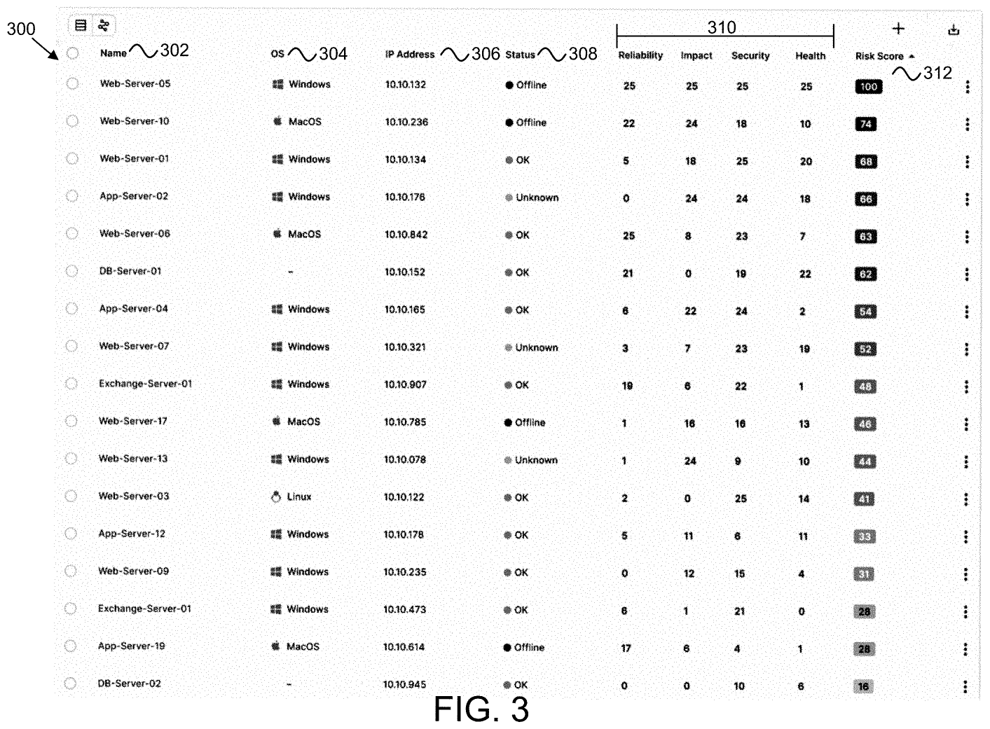

FIG. 3 depicts an example interface 300 for presenting risk analysis information for network assets. In one embodiment, the interface 300 includes a name 302 or identifier for a network asset, an operating system 304 that is running on the network asset, an IP address 306 (or other address) on the network, a current status 308 of the network asset, the scores 310 for each of the dimensions that are used to calculate the risk level for the network asset, e.g., reliability, impact, security, and health, and the risk level/score 312 for the network asset.

In certain embodiments, the interface 300 allows a user to select and sort by different columns, e.g., to proactively mitigate risk, a user may sort the list by the overall risk score/level 312 to address network assets that pose the highest risk to the business, service, or the like. In another example, to protect the company's brand, the user may sort the list by the security score 310 to address assets that pose the highest security threat to that could damage the company's brand, reputation, or the like.

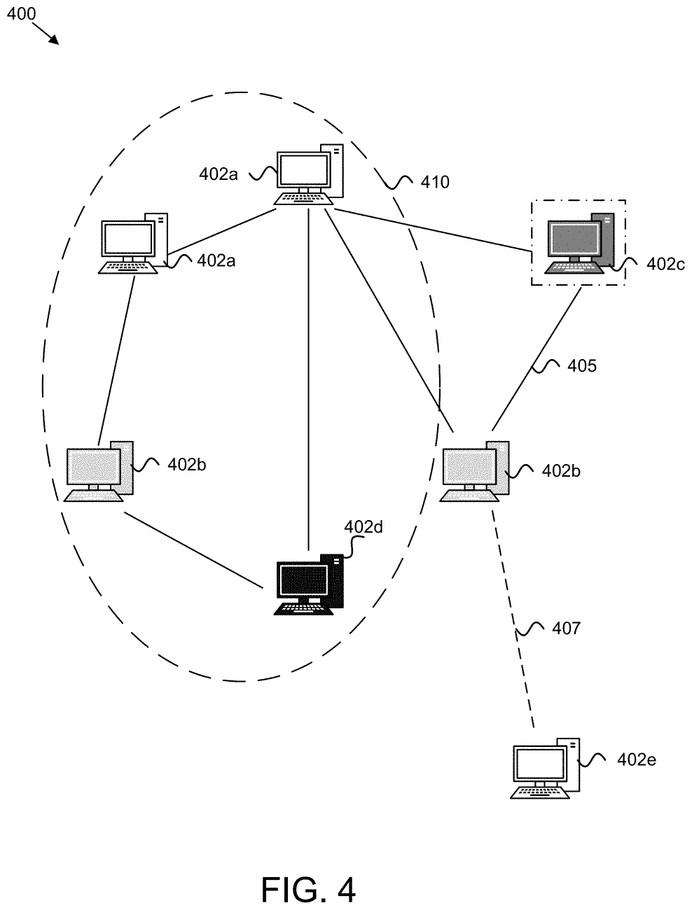

FIG. 4 depicts one embodiment of a network topology map 400 for a data network that is used to provide a service. The map 400 may be a snapshot of the network at a point in time. In one embodiment, the map 400 presents graphical representations of a plurality of network assets 402a-d (collectively 402), and the interconnections or dependencies 405 between the network assets 402. The map 400 may highlight different characteristics of the network assets 402 and the data network in general.

For instance, a logical grouping 410 of network assets 402 may be highlighted to indicate the network assets 402 that are involved in providing a service, e.g., a service group. In further embodiments, a network asset 402 that is a high risk for the data network, such as network assets 402 that are a single point of failure, e.g., network asset 402c, may be visually highlighted to indicate to the user that the network asset 402 has a certain risk level.

Also, network assets may be highlighted/colored to indicate that they are part of a particular layer, e.g., an application layer, storage layer, device layer, or the like. As shown in FIG. 4, network assets 402a belong to one layer, network assets 402b belong to a different layer, as do network assts 402c and 402d. Moreover, changes in the data network may be indicated using dashed or broken lines 407 to indicate a new network asset 402e that has been added to the network. The user may select the new network asset 402e to confirm that it should be part of the network and to add it to the baseline snapshot. In further embodiments, the user may select a network asset 402, a dependency 405, or the like to see additional information such as the asset value, the asset risk level, the type of asset or dependency, and/or the like.

In one embodiment, the map 400 provides tools for selecting which layers to make visible or hidden. For example, a network asset 402c may be part of a storage layer. If the user does not want to view network assets 402 that are part of the storage layer, the user may select the storage layer to be hidden from the map 400, which would remove the graphical representations of the network assets 402 that are part of the storage layer, including their dependencies and connections to other network assets 402. Other options may be selectable including different service groups, different types of dependencies, different types of network assets, and/or the like.

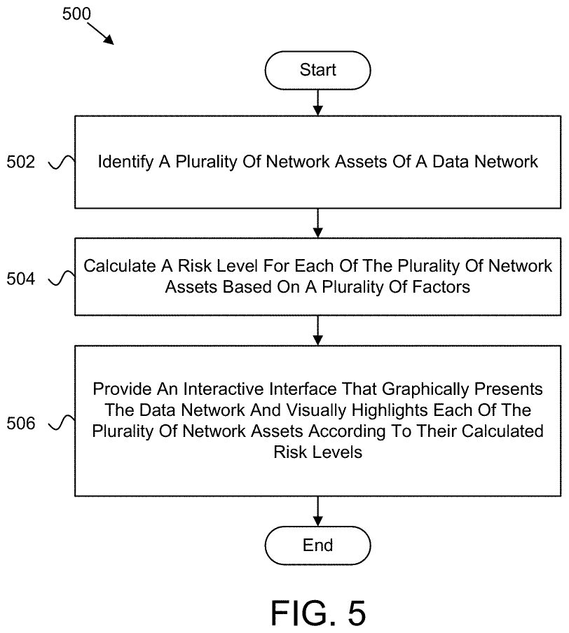

FIG. 5 depicts a schematic flow chart diagram illustrating one embodiment of a method 500 for security configuration management. In one embodiment, the method 500 begins and an asset module 202 identifies 502 a plurality of network assets of a data network. The plurality of network assets may include a plurality of interconnected physical and virtual computing components.

In one embodiment, the security module 204 calculates 504 a risk level for each of the plurality of network assets based on a plurality of factors. The risk level may describe a threat that an asset is to the data network being capable of functioning at a predetermined service level. In further embodiments, the interface module 206 provides 506 an interactive interface that graphically presents the data network and visually highlights each of the plurality of network assets according to their calculated risk levels, and the method 500 ends.

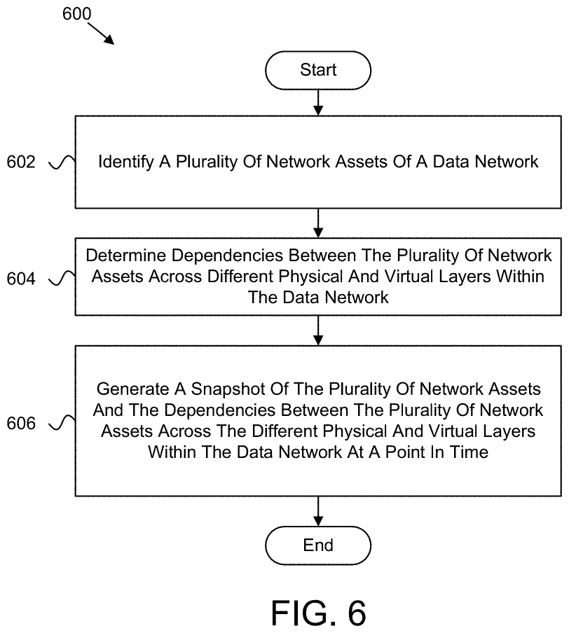

FIG. 6 depicts a schematic flow chart diagram illustrating one embodiment of a method 600 for security configuration management. In one embodiment, the method 600 begins and an asset module 202 identifies 602 a plurality of network assets of a data network. The plurality of network assets may include a plurality of interconnected physical and virtual computing components.

In further embodiments, the dependency module 212 determines 604 dependencies between the plurality of network assets across different physical and virtual layers within the data network. In one embodiment, the baseline module 214 generates 606 a snapshot of the plurality of network assets and the dependencies between the plurality of network assets across the different physical and virtual layers within the data network at a point in time, which may be used to detect changes within the data network, and the method 600 ends.

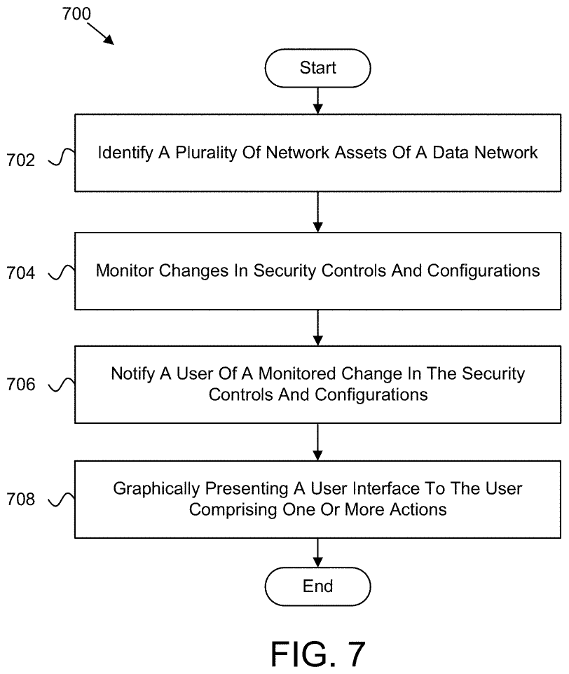

FIG. 7 depicts a schematic flow chart diagram illustrating one embodiment of a method 700 for security configuration management. In one embodiment, the method 700 begins and the asset module 202 identifies 702 a plurality of network assets of a data network. In some embodiments, the plurality of network assets comprise a plurality of interconnected physical and virtual computing components. The security module 204, in some embodiments, monitors 704 changes in security controls and configurations for the interconnected physical and virtual computing components of the network assets relative to an applied security configuration policy.

The interface module 206, in certain embodiments, notifies 706 a user of a monitored change in the security controls and configurations. The interface module 206, in one embodiment, graphically presents 708 a user interface to the user comprising one or more actions in response to the monitored 704 change and the method 700 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
an asset module that identifies a plurality of network assets of a data network, the plurality of network assets comprising a plurality of interconnected physical and virtual computing components;
a security module that monitors changes in security controls and configurations for the interconnected physical and virtual computing components of the network assets relative to an applied security configuration policy; and
an interface module that notifies a user of a monitored change in the security controls and configurations and graphically presents a user interface to the user comprising one or more actions in response to the monitored change,
wherein at least a portion of the modules comprise one or more of hardware circuits, programmable hardware circuits, and executable code, the executable code stored on one or more non-transitory computer readable storage media.

2. The apparatus of claim 1, wherein the asset module determines a baseline map comprising the identified plurality of network assets and the security controls and the security configuration policy is applied to the interconnected physical and virtual computing components in the baseline map.

3. The apparatus of claim 1, wherein monitoring the changes in the security controls and configurations for the interconnected physical and virtual computing components comprises monitoring attack vectors, applications, virtualization, the data network, and storage devices of the interconnected physical and virtual computing components.

4. The apparatus of claim 1, wherein the applied security configuration policy comprises one or more whitelists of trusted protocols for the interconnected physical and virtual computing components.

5. The apparatus of claim 4, wherein, for each of the interconnected physical and virtual computing components, the one or more whitelists define one or more trusted protocols and one or more approved directions for the one or more trusted protocols.

6. The apparatus of claim 1, wherein the applied security configuration policy comprises one or more blacklists of untrusted protocols for the interconnected physical and virtual computing components.

7. The apparatus of claim 1, wherein the applied security configuration policy comprises one or more whitelists for the interconnected physical and virtual computing components defining approved neighbors of the interconnected physical and virtual computing components.

8. The apparatus of claim 1, wherein the one or more actions comprise one or more of notification of a different user, opening an information technology service management incident, triggering orchestration, alerting a security information and event management service, quarantining one or more of the interconnected physical and virtual computing components, and reconfiguring one or more of the interconnected physical and virtual computing components.

9. The apparatus of claim 1, further comprising a forecast module that predicts an impact that each of the plurality of network assets has on a capability of the data network functioning at a predetermined service level based on the applied security configuration policy.

10. The apparatus of claim 1, wherein the interface module presents each of the plurality of network assets in the user interface and, in response to receiving a selection of one of the presented network assets, presents a status of the monitored security controls and configurations for the selected network asset.

11. The apparatus of claim 1, wherein the user interface comprises a graphical network topology map illustrating each of the plurality of network assets and network connections between the plurality of network assets, each of the plurality of network assets graphically represented on the network topology map and highlighted according to the security controls and configurations.

12. The apparatus of claim 1, wherein the user interface comprises a graphical heatmap for at least a subset of the plurality of network assets that are involved in delivering a service, the graphical heatmap providing a color-coding scheme for indicating a status of the monitored security controls and configurations for each of the subset of the plurality of network assets that are involved in delivering the service.

13. The apparatus of claim 1, wherein the one or more actions are dynamically selectable by the user within the user interface and the security module executes a selected action in response to the user selecting the selected action within the user interface.

14. The apparatus of claim 1, wherein the one or more actions are preselected and preauthorized by the user and automatically executed by the security module in response to the monitored change.

15. A method, comprising:
identifying a plurality of network assets of a data network, the plurality of network assets comprising a plurality of interconnected physical and virtual computing components;
monitoring changes in security controls and configurations for the interconnected physical and virtual computing components of the network assets relative to an applied security configuration policy;
notifying a user of a monitored change in the security controls and configurations; and
graphically presenting a user interface to the user comprising one or more actions in response to the monitored change.

16. The method of claim 15, further comprising determining a baseline map comprising the identified plurality of network assets and the security controls, wherein the security configuration policy is applied to the interconnected physical and virtual computing components in the baseline map.

17. The method of claim 15, wherein monitoring the changes in the security controls and configurations for the interconnected physical and virtual computing components comprises monitoring attack vectors, applications, virtualization, the data network, and storage devices of the interconnected physical and virtual computing components.

18. The method of claim 15, further comprising predicting an impact that each of the plurality of network assets has on the capability of the data network functioning at a predetermined service level based on the applied security configuration policy.

19. An apparatus, comprising:
means for identifying a plurality of network assets of a data network, the plurality of network assets comprising a plurality of interconnected physical and virtual computing components;
means for monitoring changes in security controls and configurations for the interconnected physical and virtual computing components of the network assets relative to an applied security configuration policy;
means for notifying a user of a monitored change in the security controls and configurations; and
means for graphically presenting a user interface to the user comprising one or more actions in response to the monitored change.

20. The apparatus of claim 19, further comprising means for predicting an impact that each of the plurality of network assets has on the capability of the data network functioning at a predetermined service level based on the applied security configuration policy.
